(19) United States
(12) Patent Application Publication
(10) Pub. No.: US 2019/0163682 A1
(43) Pub. Date: May 30, 2019

(54) ELECTRONIC APPARATUS, CONTROL DEVICE, EVENT INFORMATION PRESENTATION SYSTEM, SERVER, AND EVENT INFORMATION PRESENTATION METHOD

(71) Applicant: SHARP KABUSHIKI KAISHA, Sakai City (JP)

(72) Inventor: HIDEKI SHIGETAKE, Sakai City (JP)

(21) Appl. No.: 16/198,638

(22) Filed: Nov. 21, 2018

(30) Foreign Application Priority Data
Nov. 24, 2017 (JP) 2017-226142

(51) Int. Cl. G06F 16/2457; G06F 16/248

(52) U.S. Cl. CPC G06F 16/24575; G06F 16/248

(57) ABSTRACT

Provided is a technique to present event information at an appropriate time in consideration of the emotional state of a user resulting from presentation of the event information. An electronic apparatus (101) carries out a specifying step including specifying, with reference to an event-emotional-state characteristics information item in which an emotional state of a user and an event information item are associated with each other, an event information item that causes the emotional state of the user to transition to a target emotional state, and a presenting step including causing the presentation device to present the event information item specified in the specifying step.

This Nonprovisional application claims priority under 35 U.S.C. § 119 on Patent Application No. 2017-226142 filed in Japan on Nov. 24, 2017, the entire contents of which are hereby incorporated by reference.

### TECHNICAL FIELD

The present invention mainly relates to an electronic apparatus that presents event information.

### BACKGROUND ART

Patent Literature 1 discloses, as a conventional technique related to a system that transmits and receives messages (event information), a communication system and a communication control method which are capable of carrying out control such that, after reception of a message transmission reservation, a recipient is notified of the message at a more appropriate time, by taking into consideration the content of the message and the psychological state of the recipient.

The communication system receives, from a communication source, a reservation request to make a reservation for transmission of a message to a specific communication destination, and notifies the communication destination of the presence of the message at a predetermined time according to the content of the message and to the present or past psychological state of a user corresponding to the specific communication destination.

### CITATION LIST

### Patent Literature

### [Patent Literature 1]

PCT International Publication No. WO 2017/081894 (Publication date: May 18, 2017)

### SUMMARY OF INVENTION

### Technical Problem

A mail (event information) notification control means of the system disclosed in Patent Literature 1 is configured such that a notification is carried out when deemed appropriate according only to the “present or past psychological state” of the recipient of the mail, and does not take into consideration how the recipient actually felt after receiving the mail and having the content of the mail presented.

One or more embodiments of the present invention were made in view of the above issue, and an object thereof is to provide a technique to present event information at an appropriate time in consideration of a user's emotional state resulting from the presentation of the event information.

### Solution to Problem

In order to attain the above object, an electronic apparatus according to one or more embodiments of the present invention is an electronic apparatus including a presentation device and a control device, the control device being configured to carry out a determining step including determining an emotional state of a user, an obtaining step including obtaining an event information item related to the user, a setting step including setting a target emotional state which is a target to be reached by the emotional state of the user, a specifying step including specifying, with reference to an event-emotional-state characteristics information item in which the emotional state of the user and the event information item related to the user are associated with each other, an event information item that causes the emotional state of the user to transition to the target emotional state, and a presenting step including causing the presentation device to present the event information item specified in the specifying step.

In order to attain the above object, a control device according to one or more embodiments of the present invention is a control device configured to control an electronic apparatus that includes a presentation device, the control device including: a determining section configured to determine an emotional state of a user; an obtaining section configured to obtain an event information item related to the user; a setting section configured to set a target emotional state which is a target to be reached by the emotional state of the user; a specifying section configured to specify, with reference to an event-emotional-state characteristics information item in which the emotional state of the user and the event information item related to the user are associated with each other, an event information item that causes the emotional state of the user to transition to the target emotional state; and a presenting section configured to cause the presentation device to present the event information item specified by the specifying section.

In order to attain the above object, an event information presentation system according to one or more embodiments of the present invention is an event information presentation system including: an electronic apparatus including a presentation device, a control device, and a communication device; and a server including a server's storage device, a server control device, and a server's communication device, the control device being configured to carry out a determining step including determining an emotional state of a user, carry out an obtaining step including obtaining an event information item related to the user, carry out a setting step including setting a target emotional state which is a target to be reached by the emotional state of the user, carry out a specifying step including specifying, with reference to an event-emotional-state characteristics information item in which the emotional state of the user and the event information item related to the user are associated with each other, an event information item that causes the emotional state of the user to transition to the target emotional state, and transmit the event-emotional-state characteristics information item to the server's communication device via the communication device, the server control device being configured to carry out a storing step including storing, into the server's storage device, the event-emotional-state characteristics information item obtained via the server's communication device, the control device being configured to further carry out a presenting step including causing the presentation device to present the event information item specified in the specifying step.

In order to attain the above object, a server according to one or more embodiments of the present invention is a server including a server's storage device, a server control device, and a server's communication device, the server being connected to an electronic apparatus via the server's communication device over a network, the server control device being configured to carry out an obtaining step including obtaining, from the electronic apparatus, an event-emotional-state characteristics information item in which an emotional state of a user and an event information item related to the user are associated with each other, a storing step including storing the event-emotional-state characteristics information item into the server's storage device, and a transmitting step including transmitting, to the electronic apparatus, the event-emotional-state characteristics information item stored in the server's storage device in the storing step.

In order to attain the above object, an event information presentation method according to one or more embodiments of the present invention is an event information presentation method by which an event information presentation system carries out event information presentation, the event information presentation system including: an electronic apparatus including a presentation device; and a server connected to the electronic apparatus over a network, the method including: a determining step including determining an emotional state of a user; an obtaining step including obtaining an event information item related to the user; a setting step including setting a target emotional state which is a target to be reached by the emotional state of the user; a specifying step including specifying, with reference to an event-emotional-state characteristics information item in which the emotional state of the user and the event information item related to the user are associated with each other, an event information item that causes the emotional state of the user to transition to the target emotional state; a storing step including storing the event-emotional-state characteristics information item into the server; and a presenting step including causing the presentation device to present the event information item specified in the specifying step.

### Advantageous Effects of Invention

According to one or more embodiments of the present invention, it is possible to present event information at an appropriate time in consideration of a user's emotional state resulting from the presentation of the event information.

### BRIEF DESCRIPTION OF DRAWINGS

FIG. 1 schematically illustrates steps of an event information presentation method carried out by an electronic apparatus according to one or more embodiments of the present invention.

FIG. 2 is a block diagram illustrating a configuration of an event information presentation system in accordance with Embodiment 1 of the present invention.

FIG. 3 is for explaining data structures of a personal database and a public database.

FIG. 4 is a flowchart illustrating the event information presentation method carried out by an event information presentation system in accordance with Embodiment 1 of the present invention.

FIG. 5 is a continuation of the flowchart of FIG. 4.

FIG. 6 is a flowchart illustrating actions carried out by an emotional state observing section and an emotional state determining section of an electronic apparatus of the event information presentation system in accordance with Embodiment 1 of the present invention.

FIG. 7 is a flowchart illustrating actions carried out by an event observing section of the electronic apparatus of the event information presentation system in accordance with Embodiment 1 of the present invention.

FIG. 8 is a flowchart illustrating actions carried out by an event-emotional-state characteristics management section of the electronic apparatus of the event information presentation system in accordance with Embodiment 1 of the present invention.

FIG. 9 is a flowchart illustrating actions carried out by a held event management section of the electronic apparatus of the event information presentation system in accordance with Embodiment 1 of the present invention.

FIG. 10 is a flowchart illustrating actions carried out by an event presentation control section of the electronic apparatus of the event information presentation system in accordance with Embodiment 1 of the present invention.

FIG. 11 is a block diagram illustrating a configuration of an event information presentation system in accordance with Embodiment 2 of the present invention.

### DESCRIPTION OF EMBODIMENTS

The following description will discuss embodiments of the present invention in detail. Note, however, that the configurations described in the embodiments are for illustrative only and not intended to limit the scope of the present invention to these embodiments, unless otherwise specifically noted.

### Embodiment 1

(Overview)

An electronic apparatus according to one or more embodiments of the present invention constantly observes the emotional state of a user and controls occurrence time of an event based on an emotional-state-transition-causing characteristic of the event. In this specification, the term “emotional-state-transition-causing characteristic of an event” refers to a characteristic of an event that has the function of, if a certain event occurs when the emotional state of a user is emotional state A, causing the emotional state of the user to transition to emotional state B. Furthermore, in this specification, the term “event-emotional-state characteristics information” refers to information indicative of the emotional-state-transition-causing characteristic of the event. Note that the emotional state of a user here refers to an emotional state determined through any of various emotional state determination algorithms based on at least one kind of biological information selected from brain waves, pulse rate, blood pressure, body temperature, respiration, perspiration, action, and the like, or any combination thereof. The determination algorithms are not limited to a particular kind and may be known determination algorithms.

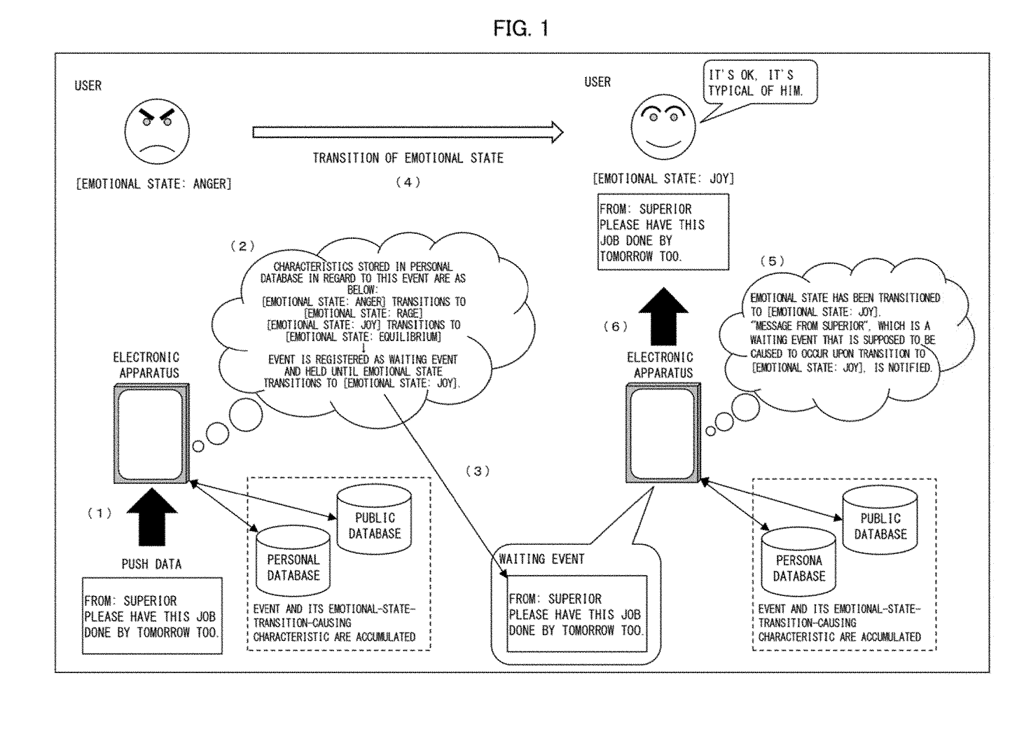

The electronic apparatus according to one or more embodiments of the present invention constantly observes the emotional state of a user. An overview of steps carried out by the electronic apparatus is described with reference to FIG. 1. FIG. 1 schematically illustrates steps (1) to (6) carried out by the electronic apparatus according to one or more embodiments of the present invention. The following description will discuss steps (1) to (6).

(1) The electronic apparatus observes an event of reception of push data (in this example, a mail with job instructions from a superior of a user) from a certain service.

(2) The electronic apparatus searches a personal database to find whether there is a record in which the observed event had caused [Emotional State: Anger] (current emotional state of the user) to transition to [Emotional State: Joy], [Emotional State: Amusement], or [Emotional State: Equilibrium]. If such a record is not found in the personal database, the electronic apparatus searches a public database. If such a record is still not found in the public database, the electronic apparatus searches for another emotional state so that, upon occurrence of the observed event, [Emotional State: Anger] will transit to the another emotional state and then the another emotional state will transition to [Emotional State: Joy], [Emotional State: Amusement], or [Emotional State: Equilibrium]. Note that the following description exemplarily discusses an arrangement in which a record, in which a user's emotional state before occurrence of an event was [Emotional State: Joy] and the user's emotional state had transitioned to [Emotional State: Equilibrium] after the occurrence of the event, is found in the personal database.

(3) The electronic apparatus holds the event (i.e., the mail with job instructions from the superior of the user) such that the held event will be released when a release condition (i.e., a condition to be met to release the held event) is met. The release condition here is a transition of the emotional state of the user to [Emotional State: Joy].

(4) The electronic apparatus observes that the emotional state of the user has changed to [Emotional State: Joy].

(5) Because the emotional state of the user has changed to [Emotional State: Joy], the electronic apparatus searches for a held event whose release condition is “transition to [Emotional State: Joy]”, and detects that the event (i.e., the mail with job instructions from the superior of the user) is held such that it will be released when the release condition “transition to [Emotional State: Joy]” is met.

(6) The electronic apparatus causes the event (i.e., the mail with job instructions from the superior of the user) to occur at the user.

(Event Information Presentation System 1)

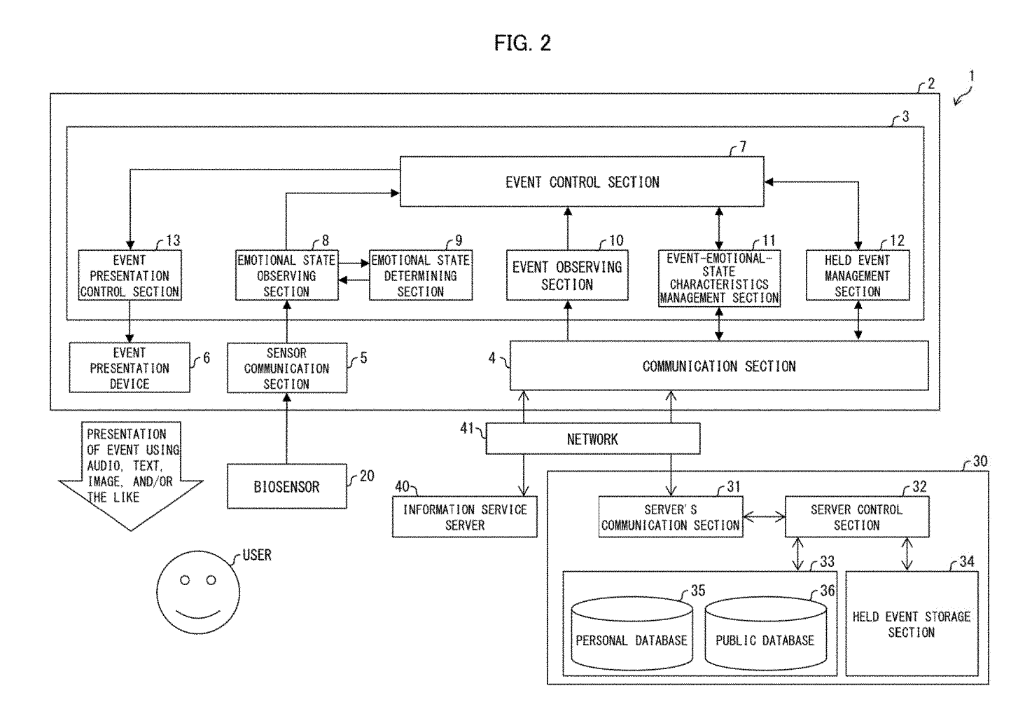

The following description will discusses an event information presentation system 1 including an electronic apparatus 2 in accordance with Embodiment 1 of the present invention with reference to FIG. 2. FIG. 2 is a block diagram illustrating a configuration of the event information presentation system 1 in accordance with Embodiment 1. As illustrated in FIG. 2, the event information presentation system 1 includes the electronic apparatus 2, a biosensor 20, and a server 30.

The electronic apparatus 2 includes a control section 3, a communication section 4, a sensor communication section 5, and an event presentation device 6. The control section 3 includes an event control section 7, an emotional state observing section 8, an emotional state determining section 9, an event observing section 10, an event-emotional-state characteristics management section 11, a held event management section 12, and an event presentation control section 13.

The event control section 7 is connected to: the emotional state observing section 8 that observes the emotional state of a user; the event observing section 10 that observes events related to the user; the event-emotional-state characteristics management section 11 that manages emotional-state-transition-causing characteristics of events related to the user; the held event management section 12 that manages events held not to occur at the user; and the event presentation control section 13 that controls the event presentation device 6 to present events to the user.

The emotional state observing section 8 is connected to the biosensor 20 via the sensor communication section 5 that communicates with the biosensor 20, and obtains biological information from the biosensor 20. The emotional state observing section 8 observes the emotional state of the user determined by the emotional state determining section 9. Note that the biosensor 20 here may be constituted by a single biosensor or two or more biosensors.

The emotional state determining section 9 determines the emotional state of the user through an emotional state determination algorithm based on the biological information received by the emotional state observing section 8 from the biosensor 20.

The event observing section 10 obtains event information from an information service server 40 (one of various kinds of service server) connected via the communication section 4 and a network 41, and observes the event information. Note that the information service server 40 here is a general service server, and does not need to have any special configuration or feature to be used in the present invention.

The event-emotional-state characteristics management section 11 is connected to a server's storage section 33. The event-emotional-state characteristics management section 11 accumulates event-emotional-state characteristics information items in a personal database 35 and a public database 36 of the server's storage section 33 via a server control section 32, and obtains the event-emotional-state characteristics information item from either of the personal database 35 and the public database 36 when necessary. In this way, the event-emotional-state characteristics management section 11 manages the event-emotional-state characteristics information items.

The held event management section 12 is connected to a held event storage section 34 via the communication section 4, the network 41, and a server's communication section 31, and stores, in the held event storage section 34 via the server control section 32, a held event and its release condition which are given by the event control section 7. The held event management section 12 also carries out management related to held events, such as retrieving, from the held event storage section 34, an event that matches a release condition given by the event control section 7.

The event presentation control section 13 controls the event presentation device 6 to present, to the user, an event represented by event information (obtained by the event observing section 10) using audio, text, image, and/or the like. Note that the event presentation device 6 here may be constituted by a single event presentation device or two or more event presentation devices.

The event presentation device 6 presents an event represented by event information using audio, text, image, and/or the like, in accordance with an instruction from the event presentation control section 13. Examples of the event presentation device 6 include displays, speakers, vibrators, LEDs, and various home appliances capable of cooperation with the event information presentation system 1.

The biosensor 20 obtains at least one kind of biological information selected from brain waves, pulse rate, blood pressure, body temperature, respiration, perspiration, action, and the like of the user. In Embodiment 1, the biosensor 20 is disposed outside the electronic apparatus 2; however, the biosensor 20 may be disposed inside the electronic apparatus 2.

The server 30 includes the server's communication section 31, the server control section 32, the server's storage section 33, and the held event storage section 34. The server 30 is connected to the electronic apparatus 2 via the server's communication section 31 over a network.

The server control section 32 reads the personal database 35, the public database 36, or a held event, from the server's storage section 33 or the held event storage section 34 in accordance with an instruction from the event observing section 10, the event-emotional-state characteristics management section 11, or the held event management section 12, and transmits it to the event observing section 10, the event-emotional-state characteristics management section 11, or the held event management section 12 via the server's communication section 31, the network 41, and the communication section 4.

The server's storage section 33 stores therein the personal database 35 and the public database 36. The personal database 35 only accumulates therein event-emotional-state characteristics information items related to an individual user. The public database 36 stores therein event-emotional-state characteristics information items related to all users, including the event-emotional-state characteristics information items accumulated in the personal database 35. Note that, although the server's storage section 33 stores therein the personal database 35 and the public database 36 in Embodiment 1, the personal database 35 and the public database 36 may be stored in a storage section of a system of a general cloud storage service in addition to or instead of the server's storage section 33.

The held event storage section 34 stores therein events placed in held state by the held event management section 12.

The information service server 40 is a general service server, and transmits, to the electronic apparatus 2 via the network 41, push data of various kinds of service, including event information. The electronic apparatus 2 observes the push data through use of the event observing section 10 via the communication section 4.

(Database)

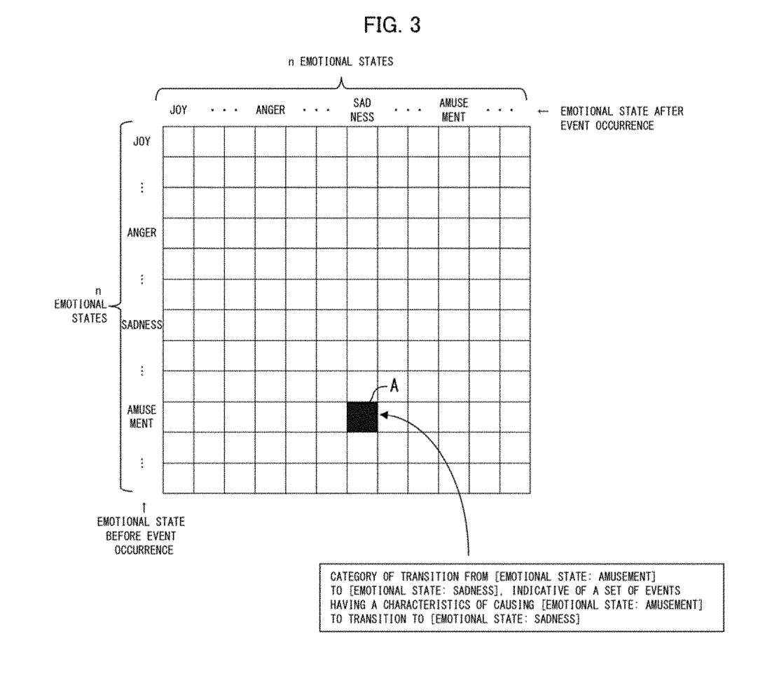

The following description will discusses data structures of the personal database 35 and the public database 36 which store therein event-emotional-state characteristics information items, with reference to FIG. 3. FIG. 3 is for explaining the data structures (event-emotional-state characteristics information) of the personal database 35 and the public database 36. There exist many kinds of emotional state, such as relieved, fearful, anticipating, thankful, calm, restless, pleased, uncomfortable, regretful, pity, satisfied, dissatisfied, nervous, disliked, humiliated, contempt, jealous, hateful, empty, impressed, and excited. Whether or not the emotional state can be determined depends on the emotional state determination algorithm to be employed. The following description will discuss an emotional state determined through an emotional state determination algorithm.

First, n emotional states are selected and, as illustrated in FIG. 3, an n×n emotional state transition matrix is defined in which the vertical axis corresponds to n emotional states before event occurrence and the horizontal axis corresponds to n emotional states after event occurrence. For example, assume here that, in a case where an occurrence of a certain event while a user is in the emotional state “amusement” resulted in a transition of the emotional state of the user into “sadness” as indicated by Element A in the matrix in FIG. 3, the event has the emotional-state-transition-causing characteristic of causing the emotional state to transition from “amusement” to “sadness”, and the event belongs to an event set (amusement, sadness). Based on the database (event-emotional-state characteristics information) constructed in this manner, it is possible to expect, before an occurrence of the event, that the occurrence of the event while the user is in the emotional state “amusement” will result in a transition of the emotional state of the user to “sadness”.

The following description more specifically discusses the personal database 35 and the public database 36 which store event-emotional-state characteristics information items therein. The event-emotional-state characteristics information is defined as below. First, n emotional states are defined, and n×n emotional state transition categories representing a transition from a certain emotional state X to a certain emotional state Y are defined. The n×n emotional state transition categories have respective event sets which belong thereto, each of which is referred to as Exy. That is, an event set Exy represents a set of events that cause a transition from the emotional state X to the emotional state Y. Note that the following arrangement may be employed: events that belong to any of the n×n emotional state transition categories are assigned attribution information such as gender, age, region, nationality, and/or the like; and events other than events that fall within these attributions can be filtered out.

Databases are classified into: a database constructed as a personal database in a storage area (which may be disposed inside the apparatus) of the server's storage section 33 managed by the electronic apparatus 2 for use by the user; and a database constructed as a public database in a storage area of the server's storage section 33 which is accessible also by other users, such as on a cloud. Note that the personal database and the public database here may be stored in a storage section of a system of a general cloud storage service other than the server's storage section 33.

The emotional state observing section 8 of the electronic apparatus 2 constantly observes the emotional state of the user, and the event-emotional-state characteristics management section 11 has the function of registering the emotional state of the user before event occurrence and the emotional state of the user after event occurrence with both the personal database 35 and the public database 36. In doing so, an event Exy, which also causes the emotional state X observed by the emotional state observing section 8 to transition to the emotional state Y, is added to elements of the corresponding event sets in these databases.

It is preferable that, when the event-emotional-state characteristics management section 11 registers an event-emotional-state characteristics information item with the public database 36, personal information (i.e., personally identifiable information) is converted into hidden form through abstraction before registration. The event-emotional-state characteristics management section 11 may assign time-based weights to events registered with the personal database 35. This makes it possible, in a case where an event-emotional-state characteristics information item is about a characteristic that varies depending on the age of an individual, to select an event that better reflects the current characteristic of the user. This is effective for the personal database 35 in which event-emotional-state characteristics information items related to an individual user only are accumulated.

Assume that the setting of the electronic apparatus 2 used by the user is such that: when the emotional state of the user is negative, a control is carried out so that an event occurrence will cause a transition to a positive state; and, when the emotional state of the user is positive, a control is carried out so that an event occurrence will cause no or little negative transition (even at worst, cause a transition to usual state). This means that, for example, in a case where the emotional state of the user is “anger, sadness” as in “joy, anger, sadness, and amusement”, an event occurrence causes a transition to an emotional state belonging to “joy, amusement”, whereas, in a case where the emotional state of the user is “joy, amusement” as in the “joy, anger, sadness, and amusement”, the event occurrence causes a transition to an emotional state belonging to “joy, amusement” or “equilibrium”. Note that the reverse setting may be employed. Alternatively, the following setting may be employed: regardless of the current emotional state of the user, only occurrence of events that cause a transition to an emotional state belonging to “joy” are allowed to occur.

The electronic apparatus 2 is configured such that, in a case where the emotional state observing section 8 has observed that the emotional state of the user is emotional state A when a “certain event E” is to be caused to occur at the user, the event-emotional-state characteristics management section 11 obtains an event set {Eab, Eac, Ead . . . } from the personal database 35. The event set {Eab, Eac, Ead . . . } is a set of events that cause the emotional state A to transition to any of positive emotional states contained in the set {emotional state B, emotional state C, emotional state D, . . . }.

In a case where the “certain event E” is contained in the event set that the event-emotional-state characteristics management section 11 has obtained from the personal database 35, the event presentation control section 13 controls the event presentation device 6 to present the “certain event E”.

In a case where the “certain event E” is not contained in the event set obtained from the personal database 35, the event-emotional-state characteristics management section 11 obtains an event set under the same condition from the public database 36. In a case where the “certain event E” is contained in the event set obtained from the public database 36, the event presentation control section 13 controls the event presentation device 6 to present the “certain event E”.

In a case where the “certain event E” is not contained in the event set obtained from the public database 36, the event-emotional-state characteristics management section 11 searches events sets of all categories of the personal database 35 to find whether the “certain event E” is registered.

If the “certain event E” exists in the personal database 35, it is possible to know what emotional state (assume here that such an emotional state is emotional state X) of the user will transition to one of the positive emotional states in the positive emotional state set upon occurrence of the “certain event E”. Accordingly, the held event management section 12 holds the occurrence of the “certain event E” until the emotional state of the user transitions to the emotional state X.

In a case where the “certain event E” does not exist in the personal database 35, the event-emotional-state characteristics management section 11 similarly searches the public database 36, and the held event management section 12 carries out a similar process to the case of the personal database 35.

It follows that, in a case where the “certain event E” exists neither in the personal database 35 nor the public database 36, the event presentation control section 13 controls the event presentation device 6 to present the “certain event E”. The emotional state observing section 8 observes emotional state Y, which results from the occurrence of the “certain event E” during the emotional state A, and the event-emotional-state characteristics management section 11 registers the certain event E, as information of a new event, with the event set Eay in the personal database 35 and in the public database 36.

The event-emotional-state characteristics management section 11 may be configured to, when the emotional state of the user before occurrence of a certain event and the emotional state of the user after the occurrence of the certain event are registered with event sets of the corresponding categories of both the personal database 35 and the public database 36, if the same event already exists, increase the strength attribute of that event. That is, the event-emotional-state characteristics management section 11 becomes capable of selecting the event with the highest strength from an event set having the characteristic of causing the emotional state of the user to transition from the emotional state A to the emotional state B.

(Event Information Presentation Method)

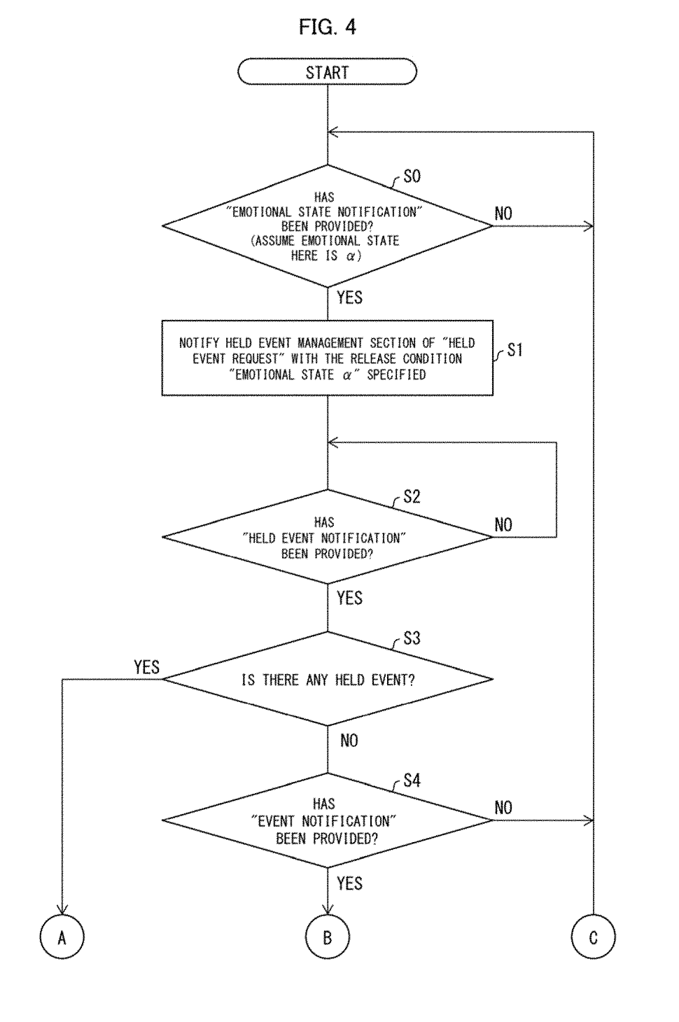

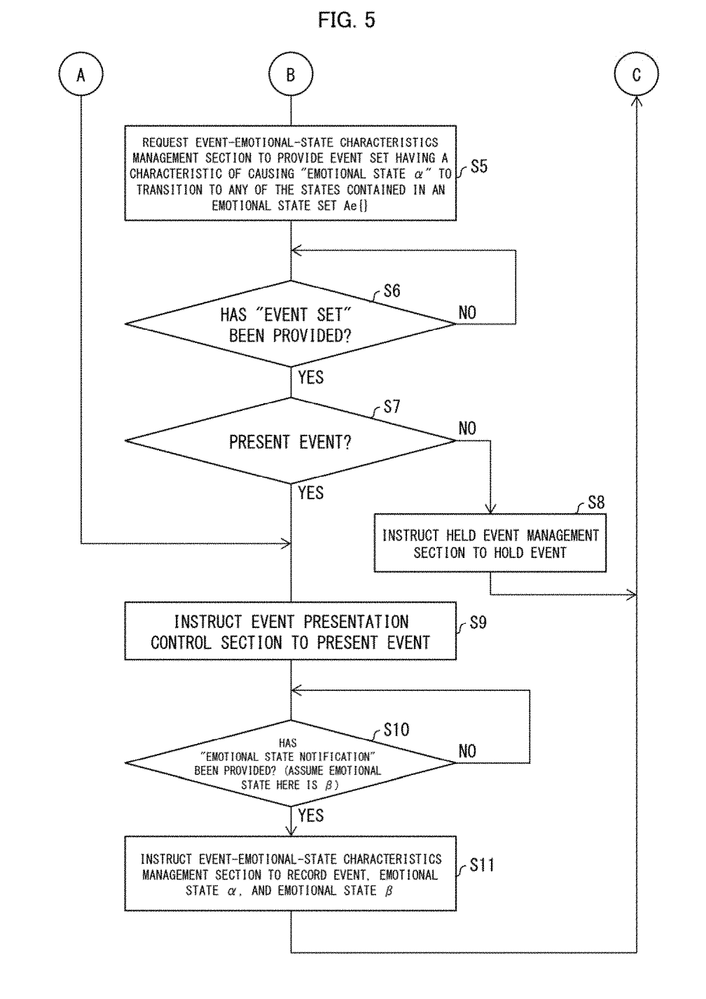

The following description will discuss an event information presentation method carried out by the event information presentation system 1 in accordance with Embodiment 1, with reference to FIGS. 4 and 5. FIG. 4 is a flowchart illustrating the event information presentation method carried out by the event information presentation system 1 in accordance with Embodiment 1. FIG. 5 is a continuation of the flowchart of FIG. 4.

First, the event control section 7 determines whether or not an “emotional state notification” has been provided from the emotional state observing section 8 (step S0). If it is determined that an “emotional state notification” has been provided from the emotional state observing section 8 (YES in step S0), the event control section 7 obtains information related to the notified emotional state (assume here that the notified emotional state is “emotional state α”), and the process proceeds to step S1. If it is determined that an “emotional state notification” has not been provided from the emotional state observing section 8 (NO in step S0), the event control section 7 repeats the process of step S0 until an “emotional state notification” is provided from the emotional state observing section 8.

In step S1, the event control section 7 notifies the held event management section 12 of a “held event request”, with the release condition “emotional state α” specified.

Next, the event control section 7 determines whether or not a “held event notification” has been provided from the held event management section 12 (step S2). If it is determined that a “held event notification” has been provided from the held event management section 12 (YES in step S2), the process proceeds to step S3. If it is determined that a “held event notification” has not been provided (NO in step S2), the event control section 7 repeats the process of step S2 until a “held event notification” is provided from the held event management section 12.

In step S3, the event control section 7 determines whether or not a held event set notified by the “held event notification” from the held event management section 12 is 0 (empty set). If it is determined that the held event set notified by the “held event notification” is not 0 (empty set) (NO in step S3), the process proceeds to step S9. If it is determined that the held event set notified by the “held event notification” is 0 (empty set) (YES in step S3), the process proceeds to step S4.

In step S4, the event control section 7 determines whether or not an “event notification” has been provided from the event observing section 10. If it is determined that an “event notification” has been provided from the event observing section 10 (YES in step S4), the process proceeds to step S5. If it is determined that an “event notification” has not been provided from the event observing section 10 (NO in step S4), the process returns to step S0.

In step S5, the event control section 7 requests the event-emotional-state characteristics management section 11 to provide an event set (event-emotional-state characteristics information) having a characteristic that causes “emotional state α” obtained in step S0 to transition to any of the states contained in an emotional state set Ae{ } (target emotional state). The emotional states in the emotional state set Ae{ } (target emotional states) here are set by the event-emotional-state characteristics management section 11 based on an emotional-state-transition-causing characteristic of the electronic apparatus 2 or an emotional-state-transition-causing characteristic that is pre-set by the electronic apparatus 2.

The emotional-state-transition-causing characteristic of the electronic apparatus 2 here refers to a characteristic that defines in what emotional state the user is placed by the electronic apparatus 2. The emotional-state-transition-causing characteristic of the electronic apparatus 2 can be, for example, when described in terms of the feelings “joy, anger, sadness, and amusement”, a characteristic that causes a transition to a positive state “joy, amusement”, or can be a characteristic that causes a transition to a negative state “anger, sadness” which is opposite to the positive state. Note that a set of n defined emotional states can be used as an emotional-state-transition-causing characteristic.

In step S6, the event control section 7 determines whether or not the “event set” (event-emotional-state characteristics information) has been provided from the event-emotional-state characteristics management section 11. The “event set” here may be accompanied by an “emotional state set” (a set of information items about emotional states before transition by event information). The details of the “event set” and “emotional state set” will be described later. If it is determined that the “event set” has been provided from the event-emotional-state characteristics management section 11 (YES in step S6), the process proceeds to step S7. If an “event set” has not been provided from the event-emotional-state characteristics management section 11 (NO in step S6), the event control section 7 repeats the process of step S6 until the “event set” is provided from the event-emotional-state characteristics management section 11.

In step S7, the event control section 7 determines whether or not the “event set” provided from the event-emotional-state characteristics management section 11 is 0 (empty set) and, if the “event set” is accompanied by the “emotional state set”, further determines whether or not the “emotional state set” is 0 (empty set), thereby determining whether or not to present an event. If it is determined that the “event set” provided from the event-emotional-state characteristics management section 11 is 0 (empty set) and that the “emotional state set” provided from the event-emotional-state characteristics management section 11 is 0 (empty set) (YES in step S7), the process proceeds to step S9. On the other hand, if it is determined that the “event set” provided from the event-emotional-state characteristics management section 11 is 0 (empty set) and that the “emotional state set” provided from the event-emotional-state characteristics management section 11 is not 0 (empty set) (NO in step S7), the process proceeds to step S8. In a case where the “event set” alone is provided and it is determined that the “event set” is not 0 (empty set) (YES in step S7), the process proceeds to step S9.

To summarize step S7, in a case where the event control section 7 has specified an event set that causes the emotional state of the user to transition to a target emotional state, the process proceeds to step S9. In a case where the event control section 7 has failed to specify an event set that causes the emotional state of the user to transition to the target emotional state and also failed to specify a set of information items about emotional states before transition by event information, the process proceeds to step S9. On the other hand, in a case where the event control section 7 has failed to specify an event set that causes the emotional state of the user to transition to the target emotional state but succeeded in specifying a set of information items about emotional states before transition by event information, the process proceeds to step S8 (step of holding event information).

In step S8, the event control section 7 instructs the held event management section 12 to hold the event notified by the event observing section 10 in step S4, using the “emotional state set” received from the event-emotional-state characteristics management section 11 as a release condition. Then, the process returns to step S0.

On the other hand, in step S9, the event control section 7 instructs the event presentation control section 13 to sequentially present, to the user, the events contained in the held event set notified from the held event management section 12 in step S3. Alternatively, the event control section 7 instructs the event presentation control section 13 to present, to the user, the event notified from the event observing section 10 in step S4.

In step S10, the event control section 7 determines whether or not an “emotional state notification” has been provided from the emotional state observing section 8, as with step S0. If it is determined that an “emotional state notification” has been provided from the emotional state observing section 8 (YES in step S10), the event control section 7 obtains information about the notified emotional state (assume here that the emotional state is “emotional state β”), and the process proceeds to step S11. If it is determined that an “emotional state notification” has not been provided from the emotional state observing section 8 (NO in step S10), the event control section 7 repeats the process of step S10 until an “emotional state notification” is provided from the emotional state observing section 8.

In step S11, the event control section 7 instructs the event-emotional-state characteristics management section 11 to record the event presented to the user in step S9, the “emotional state α” of the user before the occurrence of the event, and the “emotional state β” (emotional state of the user after the occurrence of the event) obtained in step S10. Then, the process returns to step S0.

(Emotional State Observing Section 8, Emotional State Determining Section 9)

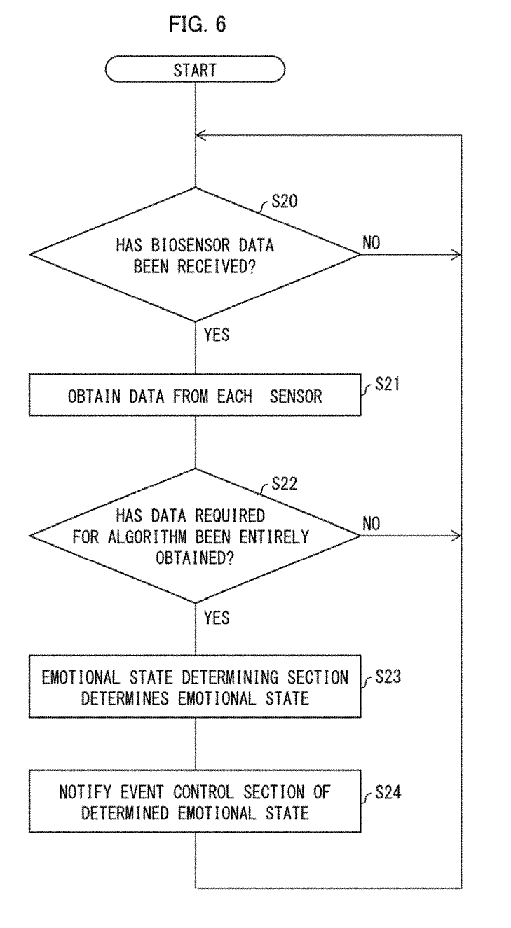

The following description will discuss actions carried out by the emotional state observing section 8 and the emotional state determining section 9 included in the control section 3 of the electronic apparatus 2 in accordance with Embodiment 1, with reference to FIG. 6. FIG. 6 is a flowchart illustrating the actions carried out by the emotional state observing section 8 and the emotional state determining section 9.

First, the emotional state observing section 8 determines whether or not biological data has been received from the biosensor 20 via the sensor communication section 5 (step S20). If it is determined by the emotional state observing section 8 that biological data has been received (YES in step S20), the process proceeds to step S21. If it is determined by the emotional state observing section 8 that biological data has not been received (NO in step S20), the process returns to step S20 and the emotional state observing section 8 repeats the process of step S20 until biological data is received.

In step S21, the emotional state observing section 8 obtains the biological data that was received in step S20.

Next, the emotional state observing section 8 determines whether or not the biological data required for an emotional state determination algorithm of the emotional state determining section 9 has been entirely obtained (step S22). If it is determined that the biological data required for the emotional state determination algorithm of the emotional state determining section 9 has been entirely obtained (YES in step S22), the process proceeds to step S23. If it is determined that the biological data required for the emotional state determination algorithm of the emotional state determining section 9 has not been entirely obtained (NO in step S22), the process returns to step S20, and steps S20, S21, and S22 are repeated until the biological data required for the emotional state determination algorithm of the emotional state determining section 9 is entirely obtained.

In step S23, the emotional state observing section 8 transmits the obtained biological data to the emotional state determining section 9, instructs the emotional state determining section 9 to determine an emotional state, and obtains information about the emotional state determined by the emotional state determining section 9.

Next, the emotional state observing section 8 notifies the event control section 7 of the information about the emotional state obtained in step S23 (step S24). Then, the process returns to step S20.

(Event Observing Section 10)

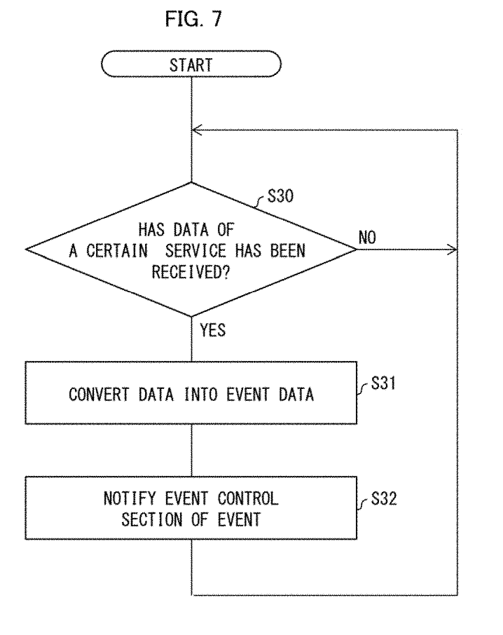

The following description will discuss actions carried out by the event observing section 10 included in the control section 3 of the electronic apparatus 2 in accordance with Embodiment 1, with reference to FIG. 7. FIG. 7 is a flowchart illustrating the actions carried out by the event observing section 10.

First, the event observing section 10 determines whether or not push data of a certain service has been received from the information service server 40 on a cloud (step S30). If it is determined by the event observing section 10 that push data of a certain service has been received (YES in step S30), the process proceeds to step S31. If it is determined by the event observing section 10 that push data of a certain service has not been received (NO in step S30), the event observing section 10 repeats the process of step S30 and waits until push data of a certain service is received from the server 30.

In step S31, the event observing section 10 converts the push data of a certain service received in step S30 into event data.

The conversion into event data in step S31 here refers to a conversion that is carried out in order to treat each service data as systematic event data. The data systematization here is not limited to a particular kind, and is, for example, the following process: various service categories (such as mail, SNS, telephone, and various kinds of notification information) are assigned identifies; services in each of the service categories are assigned respective identifiers; and the content of each service data is subjected to a morphological analysis if the service data is text data or data resulted from conversion of audio data into text data.

In the step subsequent to step S31, the event observing section 10 notifies the event control section 7 of the event data resulted from the conversion in step S31 (step S32). Then, the process returns to step S30, and steps S30 to S32 are repeated.

(Event-Emotional-State Characteristics Management Section 11)

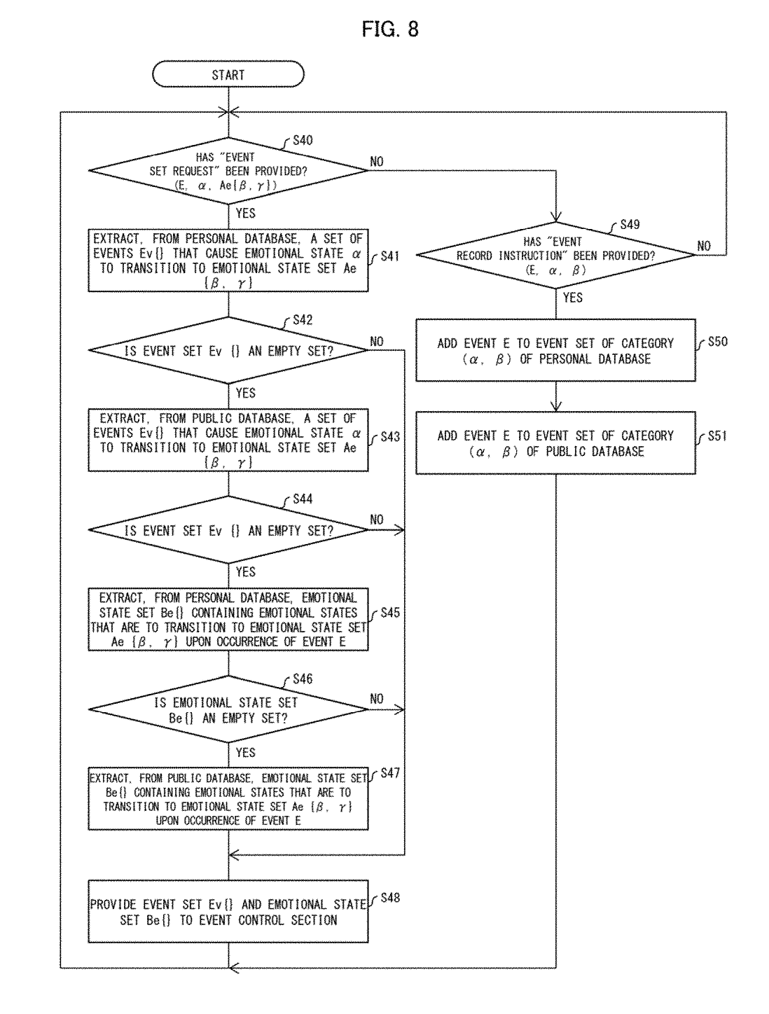

The following description will discuss actions carried out by the event-emotional-state characteristics management section 11 included in the control section 3 of the electronic apparatus 2 in accordance with Embodiment 1, with reference to FIG. 8. FIG. 8 is a flowchart illustrating the actions carried out by the event-emotional-state characteristics management section 11.

First, the event-emotional-state characteristics management section 11 determines whether or not an “event set request” has been provided from the event control section 7 (step S40). If it is determined that an “event set request” has been provided (YES in step S40), the event-emotional-state characteristics management section 11 obtains event data E accompanying the “event set request”, the emotional state α (the current emotional state of the user) observed by the emotional state observing section 8, and an emotional state set Ae {β, γ} containing emotional states to which the user's emotional state is desired to transition after event occurrence (assume here that the user's emotional state is desired to transition to emotional state β or emotional state γ). Then, the process proceeds to step S41. If it is determined that an “event set request” has not been provided (NO in step S40), the process proceeds to step S49.

In step S41, the event-emotional-state characteristics management section 11 obtains a set of events that cause the emotional state α to transition to any of the emotional states contained in the emotional state set Ae {β,γ} (target emotional state), that is, a set of events that cause the emotional state α to transition to the emotional state β or cause the emotional state α to transition to the emotional state γ (such a set is referred to as Ev{ }), by extracting the set of events from the personal database 35 (which is stored in the server's storage section 33 or in a storage section of a system of a general cloud storage service) on the cloud via the communication section 4.

Next, the event-emotional-state characteristics management section 11 determines whether or not the event set Ev { } obtained in step S41 is an empty set (step S42). If it is determined that the event set Ev { } is an empty set (YES in step S42), the process proceeds to step S43. If it is determined that the event set Ev { } is not an empty set (NO in step S42), the process proceeds to step S48.

In step S43, the event-emotional-state characteristics management section 11 obtains a set of events Ev{ } that cause the emotional state α to transition to any of the emotional states contained in the emotional state set Ae {β,γ}, that is, a set of events that cause the emotional state α to transition to the emotional state β or cause the emotional state α to transition to the emotional state γ, by extracting the set of events from the public database 36 (which is stored in the server's storage section 33 or in a storage section of a system of a general cloud storage service) on the cloud via the communication section 4.

Next, the event-emotional-state characteristics management section 11 determines whether or not the event set Ev{ } obtained in step S43 is an empty set (step S44). If it is determined that the event set Ev{ } is an empty set (YES in step S44), the process proceeds to step S45. If it is determined that the event set Ev{ } is not an empty set (NO in step S44), the process proceeds to step S48.

In step S45, the event-emotional-state characteristics management section 11 obtains a set of emotional states (referred to as emotional state set Be{ }) of the user that are to transition to any of the emotional states contained in the emotional state set Ae {β,γ} upon occurrence of the event E, that is, a set of emotional states of the user that are to transition to the emotional state β or the emotional state γ upon occurrence of the event E, by extracting the set of emotional states from the personal database 35 on the cloud via the communication section 4.

Next, the event-emotional-state characteristics management section 11 determines whether or not the emotional state set Be{ } obtained in step S45 is an empty set (step S46). If it is determined that the emotional state set Be{ } is an empty set (YES in step S46), the process proceeds to step S47. If it is determined that the emotional state set Be{ } is not an empty set (NO in step S46), the process proceeds to step S48.

In step S47, the event-emotional-state characteristics management section 11 obtains a set of emotional states (referred to as emotional state set Be{ }) of the user that are to transition to any of the emotional states contained in the emotional state set Ae {β,γ} upon occurrence of the event E, that is, a set of emotional states of the user that are to transition to the emotional state β or the emotional state γ upon occurrence of the event E, by extracting the set of emotional states from the public database 36 on the cloud via the communication section 4.

In step S48, the event-emotional-state characteristics management section 11 provides, to the event control section 7, the event set Ev{ } and the emotional state set Be{ } (if this was obtained in step S45) as an “event set notification”. Then, the process returns to step S40.

In step S49 (the step subsequent to step S40 in the case of NO in step S40), the event-emotional-state characteristics management section 11 determines whether or not an “event record instruction” has been provided from the event control section 7. If it is determined that an “event record instruction” has been provided (YES in step S49), the event-emotional-state characteristics management section 11 obtains data of the event E accompanying the “event record instruction”, the emotional state α of the user before occurrence of the event E, and the emotional state β of the user after the occurrence of the event E. Then, the process proceeds to step S50. If it is determined that an “event record instruction” has not been provided (NO in step S49), the process returns to step S40.

In step S50, the event-emotional-state characteristics management section 11 adds the event E to an event set of the category (α, β) of the personal database 35 on the cloud via the communication section 4.

Next, in step S51, the event-emotional-state characteristics management section 11 adds the event E to an event set of the category (α, β) of the public database 36 on the cloud via the communication section 4, and the process returns to step S40.

Note that, although the arrangement employed here is such that the personal database 35 resides on a cloud and the personal database 35 is accessed via the communication section 4, the personal database 35 may be provided within the electronic apparatus 2. In a case where the personal database 35 is provided within the electronic apparatus 2, the event-emotional-state characteristics management section 11 does not need to access the personal database 35 via the communication section 4. As is clear from this, there is no limitation as to where to provide the personal database 35.

(Held Event Management Section 12)

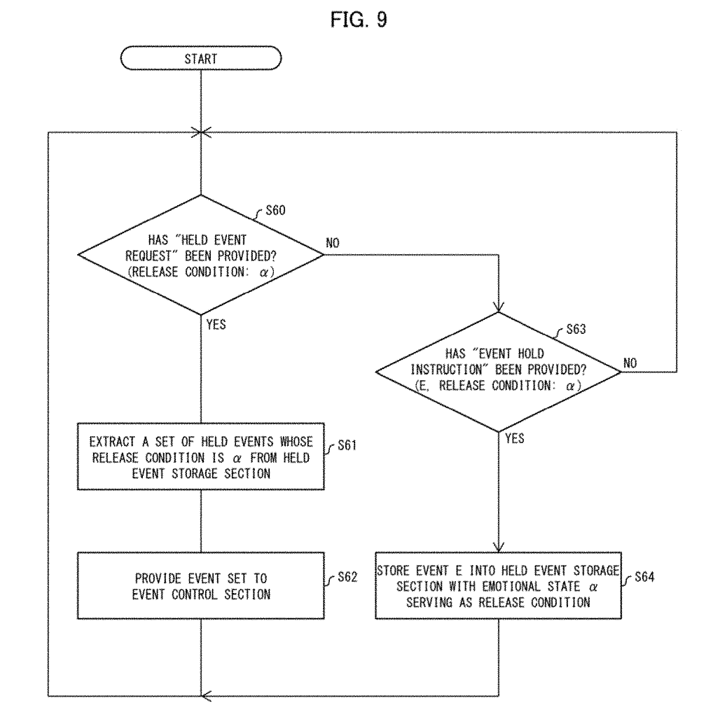

The following description will discuss actions carried out by the held event management section 12 included in the control section 3 of the electronic apparatus 2 in accordance with Embodiment 1, with reference to FIG. 9. FIG. 9 is a flowchart illustrating the actions carried out by the held event management section 12.

First, the held event management section 12 determines whether or not a “held event request” has been provided from the event control section 7 (step S60). If it is determined that a “held event request” has been provided (YES in step S60), the held event management section 12 obtains the emotional state α, which is a release condition for the event accompanying the “held event request” to be released, and the process proceeds to steps S61. If it is determined that a “held event request” has not been provided (NO in step S60), the process proceeds to step S63.

In step S61, the held event management section 12 extracts a held event whose release condition is the emotional state α, from the held event storage section 34 on the cloud via the communication section 4.

Next, the held event management section 12 provides, to the event control section 7, a set of held events obtained in step S61 as a “held event notification” (step S62), and the process returns to step S60.

In step S63 (the step subsequent to step S60 in the case of NO in step S60), the held event management section 12 determines whether or not an “event hold instruction” has been provided from the event control section 7. If it is determined that an “event hold instruction” has been provided (YES in step S63), the held event management section 12 obtains data of the event E accompanying the “event hold instruction” and the emotional state α serving as a release condition, and the process proceeds to step S64. If it is determined that an “event hold instruction” has not been provided (NO in step S63), the process returns to step S60.

In step S64, the held event management section 12 stores, into the held event storage section 34 on the cloud via the communication section 4, the data of the event E together with the emotional state α serving as the release condition. Then, the process returns to step S60.

Note that, although the arrangement employed here is such that the held event storage section 34 resides on a cloud and the held event storage section 34 is accessed via the communication section 4, the held event storage section 34 may be provided within the electronic apparatus 2. In a case where the held event storage section 34 is provided within the electronic apparatus 2, the held event management section 12 does not need to access the held event storage section 34 via the communication section 4. As is clear from this, there is no limitation as to where to provide the held event storage section 34.

(Event Presentation Control Section 13)

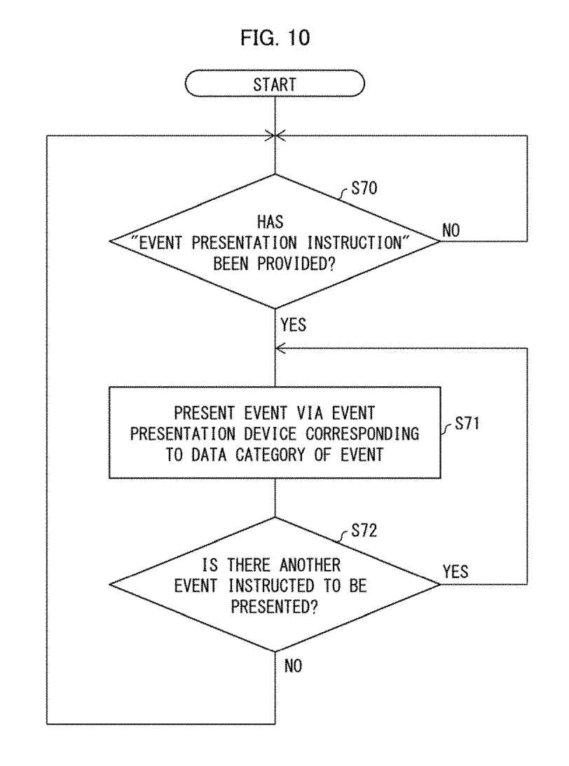

The following description will discuss actions carried out by the event presentation control section 13 included in the control section 3 of the electronic apparatus 2 in accordance with Embodiment 1, with reference to FIG. 10. FIG. 10 is a flowchart illustrating the actions carried out by the event presentation control section 13.

First, the event presentation control section 13 determines whether or not an “event presentation instruction” has been provided from the event control section 7 (step S70). If it is determined that an “event presentation instruction” has been provided (YES in step S70), the process proceeds to step S71. If it is determined that an “event presentation instruction” has not been provided (NO in step S70), the event presentation control section 13 repeats step S70 and waits until an “event presentation instruction” is provided from the event control section 7.

In step S71, the event presentation control section 13 presents, to the user, an event instructed by the event control section 7 to be presented, via the event presentation device 6 that corresponds to the data category (e.g., text, audio, image, video, or any of various home appliance controls) of that event.

Next, the event presentation control section 13 determines whether or not there is another event instructed by the event control section 7 to be presented, in addition to the event presented in step S71 (step S72). If it is determined that there is such another event (YES in step S72), the process returns to step S71, and the event presentation control section 13 controls the event presentation device 6 to present such another event. If it is determined that there is no such another event, the process returns to step S70.

(Recap)

As has been described, the event information presentation system 1 in accordance with Embodiment 1 includes the electronic apparatus 2 and the server 30, the electronic apparatus 2 is configured to: carry out a determining step including determining an emotional state of a user; carry out an obtaining step including obtaining an event information item related to the user; carry out a setting step including setting a target emotional state which is a target to be reached by the emotional state of the user; carry out a specifying step including specifying, with reference to an event-emotional-state characteristics information item in which the emotional state of the user and the event information item related to the user are associated with each other, an event information item that causes the emotional state of the user to transition to the target emotional state; and transmit the event-emotional-state characteristics information item to the server's communication section 31 via the communication section 4, the server 30 is configured to carry out a storing step including storing, into the server's storage section 33 of the server 30, the event-emotional-state characteristics information item obtained via the server's communication section 31, and the electronic apparatus 2 is configured to further carry out a presenting step including causing the event presentation device 6 of the electronic apparatus 2 to present the event information item specified in the specifying step.

According to the above arrangement, it is possible to specify event information that causes the emotional state of the user to transition to the target emotional state. This makes it possible to present the event information at an appropriate time in consideration of the user's emotional state resulting from the presentation of the event information.

Furthermore, the earlier-mentioned invention disclosed in Patent Literature 1 has an issue in that a message sender needs to use a special message notification system in accordance with a conventional invention.

In contrast, according to the event information presentation system 1 in accordance with Embodiment 1, a single electronic apparatus is capable of carry out all the functions of: determining the emotional state of a user; obtaining event information; generating event-emotional-state characteristics information based on the emotional state of the user and the event information; and displaying event information corresponding to the event-emotional-state characteristics information. This eliminates the need for a special message notification system except for the server that stores therein the event-emotional-state characteristics information.

Furthermore, according to the conventional technique, although a message transmission control is carried out according to the “present or past psychological state” of a recipient, it is unknown whether an intended result was obtained through the transmission control (i.e., whether the emotional state of the recipient user has changed to an intended state), that is, such a result is not fed back to the system. The conventional technique thus has an issue in that it is unknown whether the control of the system was a correct and intended control, and that the system control is not improved.

In view of this, the event information presentation system 1 in accordance with Embodiment 1 is configured such that the electronic apparatus carries out the determining step including determining the emotional state of the user before and after the presenting step that includes presenting the specified event information item, and further carries out a generating step including generating the event-emotional-state characteristics information item in which the emotional state determined in the determining step carried out before the presenting step, the emotional state determined in the determining step carried out after the presenting step, and the event information item presented in the presenting step, are associated with one another.

According to the above arrangement, with reference to the generated event-emotional-state characteristics information item, an event control such as notifying an event message is carried out in consideration of the transition of the emotional state of the user between before and after the occurrence of the event. Furthermore, the result of the occurrence of the event is also fed back to the database(s) in the storage device. This makes it possible to, with reference to the event-emotional-state characteristics information item stored through the feedback, cause the event to occur at a more appropriate time, and also possible to gradually improve the success rate of the control.

Furthermore, conventional techniques have an issue in that, in a case where the content of a message (event information) is unprecedented content, it is impossible to carry out an event presentation control in consideration of the emotional state of the user.

In view of this, according to the event information presentation system 1 in accordance with Embodiment 1, the server's storage section 33 of the server 30 stores therein the personal database 35 and the public database 36, and the emotional states of the user before and after the occurrence of an event at the user are consecutively stored in the personal database 35 and the public database 36. In addition, events related to many other users and emotional states of those users before and after each event are also consecutively stored in the public database 36, with the result that a tremendous amount of data is stored in the public database 36. It follows that the likelihood that an event that has never been experienced by anyone will occur at the user is dramatically reduced, thereby making it possible to, in regard to almost all kinds of event, carry out control of event presentation in consideration of the emotional state of the user.

### Embodiment 21

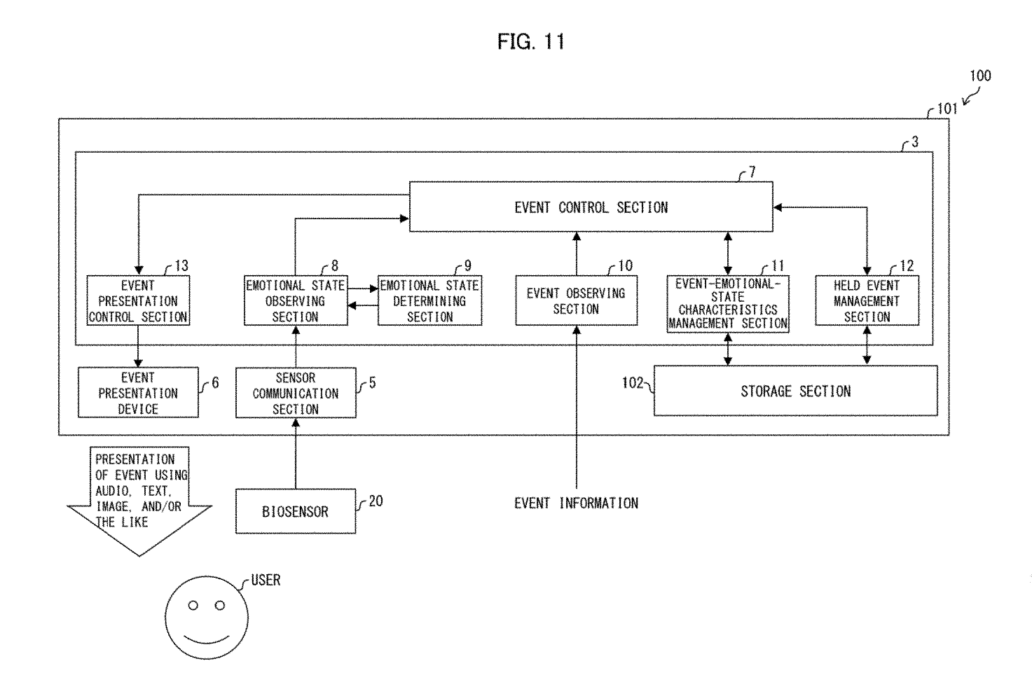

The following description will discuss Embodiment 2 of the present invention with reference to FIG. 11. FIG. 11 is a block diagram illustrating a configuration of an event information presentation system 100 in accordance with Embodiment 2. As illustrated in FIG. 11, the event information presentation system 100 in accordance with Embodiment 2 is different from the event information presentation system 1 in accordance with Embodiment 1 in that the event information presentation system 100 includes no server 30. The event information presentation system 100 in accordance with Embodiment 2 includes an electronic apparatus 101, which has the same configuration as the electronic apparatus 2 of the event information presentation system 1 in accordance with Embodiment 1 except that the electronic apparatus 101 includes a storage section 102 in place of the communication section 4. Therefore, members having functions identical to those of the event information presentation system 1 described in Embodiment 1 are assigned identical referential numerals and their descriptions are omitted.

The storage section 102 of the electronic apparatus 101 in accordance with Embodiment 2 has the functions similar to the server's storage section 33 and the held event storage section 34 described in Embodiment 1, and stores therein the personal database 35, the public database 36, and events placed in held state by the held event management section 12.

The event-emotional-state characteristics management section 11 in accordance with Embodiment 2 is connected to the storage section 102, accumulates event-emotional-state characteristics information items in the personal database and the public database of the storage section 102, and obtains the event-emotional-state characteristics information item from either of the personal database and the public database when necessary. In this way, the event-emotional-state characteristics management section 11 manages the event-emotional-state characteristics information items. Note that the storage section 102 may externally obtain event-emotional-state characteristics information related to some other user and store it in the public database.

The held event management section 12 in accordance with Embodiment 2 is connected to the storage section 102, and stores, in the storage section 102, a held event and its release condition which are given by the event control section 7. The held event management section 12 also carries out management related to held events, such as retrieving, from the storage section 102, an event that matches a release condition given by the event control section 7.

As described above, the electronic apparatus 101 that further includes the storage section 102, which serves as both the server's storage section 33 of the server 30 and the held event storage section 34 in accordance with Embodiment 1, is also encompassed in one or more embodiments of the present invention.

According to the above arrangement, a single electronic apparatus is capable of carrying out all the functions of: determining the emotional state of a user; obtaining event information; generating event-emotional-state characteristics information based on the emotional state of the user and the event information and storing the event-emotional-state characteristics information; and displaying event information corresponding to the event-emotional-state characteristics information. This eliminates the need for any other special message notification system.

[Variation 1]

The arrangement discussed in the foregoing Embodiment 1 is such that the server 30 includes: the server's storage section 33 that stores therein the personal database 35 and the public database 36; and the held event storage section 34 that stores held events therein. The arrangement discussed in the foregoing Embodiment 2 is such that the electronic apparatus 101 includes the storage section 102 which has the functions similar to those of the server's storage section 33 and the held event storage section 34. Note, however, that these arrangements do not imply any limitation as to where to provide a member serving as the server's storage section 33 and a member serving as the held event storage section 34.

For example, the following arrangement is also encompassed in embodiments of the present invention: the electronic apparatus 2 includes a storage device that stores the personal database 35 therein; and the server 30 includes a storage device that stores the public database therein and a storage device that stores held events therein.

For example, the following arrangement is also encompassed in embodiments of the present invention: the electronic apparatus 2 includes a storage device that stores therein the personal database 35 and held events; and the server 30 includes a storage device that stores the public database 36 therein.

[Variation 2]

The arrangement discussed in the foregoing Embodiment 1 is such that the event-emotional-state characteristics management section 11 extracts and obtains event-emotional-state characteristics information from the personal database 35 or the public database 36 on a cloud via the communication section 4. Note, however, that this arrangement does not imply any limitation as to how the event-emotional-state characteristics management section 11 obtains event-emotional-state characteristics information.

For example, an arrangement in which the event-emotional-state characteristics management section 11 extracts and obtains event-emotional-state characteristics information only from the public database 36 is also encompassed in embodiments of the present invention. The event control section 7 may specify event information that causes the emotional state of the user to transition to a target emotional state, with reference to the event-emotional-state characteristics information extracted only from the public database 36.

[Software Implementation Example]

Control blocks of the electronic apparatus 2 and the server 30 (particularly, the control section 3 and the server control section 32) can be realized by a logic circuit (hardware) provided in an integrated circuit (IC chip) or the like or can be alternatively realized by software.

In the latter case, the electronic apparatus 2 and the server 30 each include a computer that executes instructions of a program that is software realizing the foregoing functions. The computer includes, for example, at least one processor (control device) and also includes at least one computer-readable storage medium that stores the program therein. An object of the present invention can be achieved by the processor in the computer reading and executing the program stored in the storage medium. Examples of the processor include central processing units (CPUs). Examples of the storage medium include “a non-transitory tangible medium” such as a tape, a disk, a card, a semiconductor memory, and a programmable logic circuit, as well as read only memories (ROMs). The electronic apparatus 2 and the server 30 may further include a random access memory (RAM) or the like in which the program is loaded. The program can be supplied to or made available to the computer via any transmission medium (such as a communication network or a broadcast wave) which allows the program to be transmitted. Note that one or more embodiments of the present invention can also be achieved in the form of a computer data signal in which the program is embodied via electronic transmission and which is embedded in a carrier wave.

[Recap]

An electronic apparatus (2, 101) in accordance with Aspect 1 of the present invention is an electronic apparatus including a presentation device (event presentation device 6) and a control device (control section 3), the control device being configured to carry out a determining step including determining an emotional state of a user, an obtaining step including obtaining an event information item related to the user, a setting step including setting a target emotional state which is a target to be reached by the emotional state of the user, a specifying step including specifying, with reference to an event-emotional-state characteristics information item in which the emotional state of the user and the event information item related to the user are associated with each other, an event information item that causes the emotional state of the user to transition to the target emotional state, and a presenting step including causing the presentation device to present the event information item specified in the specifying step.

According to the above arrangement, it is possible to specify an event information item that causes the emotional state of the user to transition to the target emotional state. This makes it possible to present event information at an appropriate time in consideration of the user's emotional state resulting from the presentation of the event information.

An electronic apparatus (2, 101) in accordance with Aspect 2 of the present invention may be arranged such that, in Aspect 1, the control device is configured to, in the determining step, determine the emotional state with reference to biological information of the user obtained by a biosensor.

According to the above arrangement, it is possible to determine the emotional state of the user based on the biological information obtained by the biosensor. This eliminates the need for any other system related to the determination of the emotional state of the user.

An electronic apparatus (2, 101) in accordance with Aspect 3 of the present invention may be arranged such that, in Aspect 1 or 2, the control device is configured to further carry out a holding step including determining, with reference to the emotional state determined in the determining step and the event-emotional-state characteristics information item, whether or not to hold a presentation of the event information item obtained in the obtaining step, and storing the event information item obtained in the obtaining step into a storage device if it is determined to hold the presentation of the event information item obtained in the obtaining step, and in the presenting step, cause the presentation device to present the event information item stored in the storage device in the holding step.

According to the above arrangement, it is possible to hold the event information item depending on the emotional state of the user. Furthermore, with reference to the event-emotional-state characteristics information item in which the emotional state of the user and the event information item are associated with each other, it is possible to present the held event information item at an appropriate time.

An electronic apparatus (2, 101) in accordance with Aspect 4 of the present invention may be arranged such that, in Aspects 1 to 3, the control device is configured to carry out the determining step before and after the presenting step, and the control device is configured to further carry out a generating step including generating the event-emotional-state characteristics information item in which the emotional state determined in the determining step carried out before the presenting step, the emotional state determined in the determining step carried out after the presenting step, and the event information item presented in the presenting step are associated with one another, and a storing step including storing the event-emotional-state characteristics information item into the storage device.

According to the above arrangement, with reference to the generated event-emotional-state characteristics information item, an event control such as notifying an event message is carried out in consideration of the transition of the emotional state of the user between before and after the occurrence of the event. Furthermore, the result of the occurrence of the event is also fed back to the database(s) in the storage device. This makes it possible to, with reference to the event-emotional-state characteristics information item stored through the feedback, cause the event to occur at a more appropriate time, and also possible to gradually improve the success rate of the control.

An electronic apparatus (2, 101) in accordance with Aspect 5 of the present invention may be arranged such that, in Aspects 1 to 4, the control device is configured to, in the specifying step, specify, with reference to a public database, the event information item that causes the emotional state of the user to transition to the target emotional state, the public database storing therein the event-emotional-state characteristics information item related to the user and another event-emotional-state characteristics information item related to another user.

According to the above arrangement, the another event-emotional-state characteristics information item related to the another user stored in the public database is referenced, and thereby the likelihood that an event that has never been experienced by anyone will occur at the user is dramatically reduced. This makes it possible to, in regard to almost all kinds of event, carry out control of event presentation in consideration of the emotional state of the user.

An electronic apparatus (2, 101) in accordance with Aspect 6 of the present invention may be arranged such that, in Aspect 5, the control device is configured such that, in the specifying step, if the control device fails to specify the event information item that causes the emotional state of the user to transition to the target emotional state with reference to a personal database, the control device specifies the event information item that causes the emotional state of the user to transition to the target emotional state with reference to the public database, the personal database storing therein the event-emotional-state characteristics information item related to the user.

According to the arrangement, even if the event-emotional-state characteristics information item is indicative of an event that has not been experienced by the user and does not exist in the personal database, it is possible to specify, with reference to the public database, an event that possibly causes the emotional state of the user to transition to the target emotional state.

A control device (control section 3) in accordance with Aspect 7 of the present invention is a control device configured to control an electronic apparatus that includes a presentation device (event presentation device 6), the control device including: a determining section (emotional state determining section 9) configured to determine an emotional state of a user; an obtaining section (event observing section 10) configured to obtain an event information item related to the user; a setting section (event-emotional-state characteristics management section 11) configured to set a target emotional state which is a target to be reached by the emotional state of the user; a specifying section (event control section 7, event-emotional-state characteristics management section 11) configured to specify, with reference to an event-emotional-state characteristics information item in which the emotional state of the user and the event information item related to the user are associated with each other, an event information item that causes the emotional state of the user to transition to the target emotional state; and a presenting section (event presentation control section 13) configured to cause the presentation device to present the event information item specified by the specifying section.

The above arrangement brings about similar effects to those of the electronic apparatus in accordance with Aspect 1.

An event information presentation system (1) in accordance with Aspect 8 of the present invention is an event information presentation system including: an electronic apparatus (2) including a presentation device (event presentation device 6), a control device (control section 3), and a communication device (communication section 4); and a server (30) including a server's storage device (server's storage section 33), a server control device (server control section 32), and a server's communication device (server's communication section 31), the control device being configured to carry out a determining step including determining an emotional state of a user, carry out an obtaining step including obtaining an event information item related to the user, carry out a setting step including setting a target emotional state which is a target to be reached by the emotional state of the user, carry out a specifying step including specifying, with reference to an event-emotional-state characteristics information item in which the emotional state of the user and the event information item related to the user are associated with each other, an event information item that causes the emotional state of the user to transition to the target emotional state, and transmit the event-emotional-state characteristics information item to the server's communication device via the communication device, the server control device being configured to carry out a storing step including storing, into the server's storage device, the event-emotional-state characteristics information item obtained via the server's communication device, the control device being configured to further carry out a presenting step including causing the presentation device to present the event information item specified in the specifying step.

According to the above arrangement, a single system is capable of carry out all the functions of: determining the emotional state of a user; obtaining event information; generating event-emotional-state characteristics information based on the emotional state of the user and the event information; and displaying event information corresponding to the event-emotional-state characteristics information. This eliminates the need for any special message notification system except for the server. Furthermore, since it is possible to generate an event-emotional-state characteristics information item in which the emotional state of the user and the event information item are associated with each other and to present the event information item with reference to the event-emotional-state characteristics information item, it is possible to present, to the user, an event information item that is appropriate for the actual emotional state of the user.

A server (30) in accordance with Aspect 9 of the present invention is a server including a server's storage device (server's storage section 33), a server control device (server control section 32), and a server's communication device (server's communication section 31), the server being connected to an electronic apparatus (2) via the server's communication device over a network, the server control device being configured to carry out an obtaining step including obtaining, from the electronic apparatus, an event-emotional-state characteristics information item in which an emotional state of a user and an event information item related to the user are associated with each other, a storing step including storing the event-emotional-state characteristics information item into the server's storage device, and a transmitting step including transmitting, to the electronic apparatus, the event-emotional-state characteristics information item stored in the server's storage device in the storing step.

The above arrangement brings about similar effects to those of the server included in the event information presentation system in accordance with Aspect 8.

An event information presentation method in accordance with Aspect 10 of the present invention is an event information presentation method by which an event information presentation system (1) carries out event information presentation, the event information presentation system including: an electronic apparatus (2) including a presentation device (event presentation device 6); and a server (30) connected to the electronic apparatus over a network, the method including: a determining step including determining an emotional state of a user; an obtaining step including obtaining an event information item related to the user; a setting step including setting a target emotional state which is a target to be reached by the emotional state of the user; a specifying step including specifying, with reference to an event-emotional-state characteristics information item in which the emotional state of the user and the event information item related to the user are associated with each other, an event information item that causes the emotional state of the user to transition to the target emotional state; a storing step including storing the event-emotional-state characteristics information item into the server; and a presenting step including causing the presentation device to present the event information item specified in the specifying step.

The above arrangement brings about similar effects to those of the event information presentation system in accordance with Aspect 8.

An electronic apparatus or a server according to one or more embodiments of the present invention may be realized by a computer. In this case, the present invention encompasses: a control program for the electronic apparatus or the server which program causes a computer to operate as the foregoing sections (software elements) of the electronic apparatus or the server so that the electronic apparatus or the server can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 100 Event information presentation system
2, 101 Electronic apparatus
3 Control section
4 Communication section
5 Sensor communication section
6 Event presentation device
7 Event control section
8 Emotional state observing section
9 Emotional state determining section
Event observing section
11 Event-emotional-state characteristics management
section
12 Held event management section
13 Event presentation control section
20 Biosensor
30 Server
31 Server's communication section
32 Server control section
33 Server's storage section
34 Held event storage section
40 Information service server
41 Network
102 Storage section

1. An electronic apparatus comprising a presentation device and a control device,
the control device being configured to carry out
a determining step including determining an emotional state of a user,
an obtaining step including obtaining an event information item related to the user,
a setting step including setting a target emotional state which is a target to be reached by the emotional state of the user,
a specifying step including specifying, with reference to an event-emotional-state characteristics information item in which the emotional state of the user and the event information item related to the user are associated with each other, an event information item that causes the emotional state of the user to transition to the target emotional state, and
a presenting step including causing the presentation device to present the event information item specified in the specifying step.

2. The electronic apparatus according to claim 1, wherein the control device is configured to, in the determining step, determine the emotional state with reference to biological information of the user obtained by a biosensor.

3. The electronic apparatus according to claim 1, wherein
the control device is configured to
further carry out a holding step including determining, with reference to the emotional state determined in the determining step and the event-emotional-state characteristics information item, whether or not to hold a presentation of the event information item obtained in the obtaining step, and storing the event information item obtained in the obtaining step into a storage device if it is determined to hold the presentation of the event information item obtained in the obtaining step, and
in the presenting step, cause the presentation device to present the event information item stored in the storage device in the holding step.

4. The electronic apparatus according to claim 1, wherein
the control device is configured to
carry out the determining step before and after the presenting step, and
the control device is configured to further carry out
a generating step including generating the event-emotional-state characteristics information item in which the emotional state determined in the determining step carried out before the presenting step, the emotional state determined in the determining step carried out after the presenting step, and the event information item presented in the presenting step are associated with one another, and
a storing step including storing the event-emotional-state characteristics information item into the storage device.

5. The electronic apparatus according to claim 1, wherein the control device is configured to, in the specifying step, specify, with reference to a public database, the event information item that causes the emotional state of the user to transition to the target emotional state, the public database storing therein the event-emotional-state characteristics information item related to the user and another event-emotional-state characteristics information item related to another user.

6. The electronic apparatus according to claim 5, wherein the control device is configured such that, in the specifying step, if the control device fails to specify the event information item that causes the emotional state of the user to transition to the target emotional state with reference to a personal database, the control device specifies the event information item that causes the emotional state of the user to transition to the target emotional state with reference to the public database, the personal database storing therein the event-emotional-state characteristics information item related to the user.

7. A control device configured to control an electronic apparatus that includes a presentation device, the control device comprising:
a determining section configured to determine an emotional state of a user;
an obtaining section configured to obtain an event information item related to the user;
a setting section configured to set a target emotional state which is a target to be reached by the emotional state of the user;
a specifying section configured to specify, with reference to an event-emotional-state characteristics information item in which the emotional state of the user and the event information item related to the user are associated with each other, an event information item that causes the emotional state of the user to transition to the target emotional state; and
a presenting section configured to cause the presentation device to present the event information item specified by the specifying section.

8. An event information presentation system comprising: an electronic apparatus including a presentation device, a control device, and a communication device; and a server including a server's storage device, a server control device, and a server's communication device,
the control device being configured to
carry out a determining step including determining an emotional state of a user,
carry out an obtaining step including obtaining an event information item related to the user,
carry out a setting step including setting a target emotional state which is a target to be reached by the emotional state of the user,
carry out a specifying step including specifying, with reference to an event-emotional-state characteristics information item in which the emotional state of the user and the event information item related to the user are associated with each other, an event information item that causes the emotional state of the user to transition to the target emotional state, and
transmit the event-emotional-state characteristics information item to the server's communication device via the communication device,
the server control device being configured to
carry out a storing step including storing, into the server's storage device, the event-emotional-state characteristics information item obtained via the server's communication device,
the control device being configured to further carry out a presenting step including causing the presentation device to present the event information item specified in the specifying step.

9. A server comprising a server's storage device, a server control device, and a server's communication device, the server being connected to an electronic apparatus via the server's communication device over a network,
the server control device being configured to carry out
an obtaining step including obtaining, from the electronic apparatus, an event-emotional-state characteristics information item in which an emotional state of a user and an event information item related to the user are associated with each other,
a storing step including storing the event-emotional-state characteristics information item into the server's storage device, and
a transmitting step including transmitting, to the electronic apparatus, the event-emotional-state characteristics information item stored in the server's storage device in the storing step.

10. An event information presentation method by which an event information presentation system carries out event information presentation, the event information presentation system including: an electronic apparatus including a presentation device; and a server connected to the electronic apparatus over a network, the method comprising:
a determining step including determining an emotional state of a user;
an obtaining step including obtaining an event information item related to the user;
a setting step including setting a target emotional state which is a target to be reached by the emotional state of the user;
a specifying step including specifying, with reference to an event-emotional-state characteristics information item in which the emotional state of the user and the event information item related to the user are associated with each other, an event information item that causes the emotional state of the user to transition to the target emotional state;
a storing step including storing the event-emotional-state characteristics information item into the server; and
a presenting step including causing the presentation device to present the event information item specified in the specifying step.
